(19) United States
(12) Patent Application Publication
(10) Pub. No.: US 2024/0328892 A1
(43) Pub. Date: Oct. 3, 2024

(54) METHOD, DEVICE AND SYSTEM FOR MONITORING A TURBINE ENGINE

(71) Applicants: SAFRAN, Paris (FR); INSTITUT NATIONAL DES SCIENCES APPLIQUEES DE LYON, Villeurbanne (FR)

(72) Inventors: Dany ABBOUD, Moissy-Cramayel (FR); Mohammed EL BADAOUI, Moissy-Cramayel (FR); Jérôme ANTONI, Villeurbanne (FR); François GIRARDIN, Villeurbanne (FR); Fulbert MBAILASSEM, Villeurbanne (FR)

(73) Assignees: SAFRAN, Paris (FR); INSTITUT NATIONAL DES SCIENCES APPLIQUEES DE LYON, Villeurbanne (FR)

(21) Appl. No.: 18/576,645

(22) PCT Filed: Jun. 24, 2022
(86) PCT No.: PCT/FR2022/051257

§ 371 Date: Jan. 4, 2024

(30) Foreign Application Priority Data
Jul. 6, 2021 (FR) 2107299

(51) Int. Cl. G01M 5/00; G01M 15/14

(52) U.S. Cl. CPC G01M 5/0066; G01M 5/0016; G01M 15/14

(57) ABSTRACT

A method for monitoring a turbine engine, said method including, for at least one blade of a rotor with which the turbine engine is equipped, the steps of: obtaining a plurality of samples of at least one analogue time signal acquired by means of at least one fixed proximity sensor and representing a passage of said at least one blade in front of said at least one proximity sensor; calculating a deflection of said at least one blade for each of said samples: determining, in the form of a linear combination of sinusoidal signals, a so-called “approximation signal”, minimizing a cost function evaluating a deviation between said calculated deflections and said approximation signal; and monitoring the vibratory behavior of said at least one blade on the basis of frequencies and/or amplitudes and/or phases of the sinusoidal signals that make up said approximation signal.

### PRIOR ART

The present invention belongs to the general field of the monitoring of the operation, and therefore the state of health, of turbomachines. It more particularly relates to a method for monitoring a turbomachine by analyzing vibratory signals. It also relates to a monitoring device configured to implement said monitoring method. The invention finds a particularly advantageous application, although without limitation, in the application field of aeronautics, more particularly in the context of a monitoring of the operation of a turbomachine equipping an aircraft.

The turbomachines are used in a wide variety of applications, such as transport (in particular transport by air), civil engineering, industrial production, energy, etc. They are designed to transform the kinetic energy of a fluid into mechanical energy (and vice versa) so as to perform different functions (turbines, pumps, compressors, turbocompressors, etc.).

More particularly, the design of a turbomachine conventionally comprises a rotating assembly called “rotor” (i.e. a wheel mounted on a shaft), this rotating assembly being coupled, via bearings (rolling bearings for example), to a fixed casing called “stator”. The rotor (as well as possibly the stator) is equipped with blades (also called “vanes”) distributed over one or several circumferential lines. These blades, like any mechanical structure, are subject to vibration when excited. The excitation sources can be diverse: rotary forces intrinsic to the operation of the turbomachine, mechanical defect of the blade, excitation of origin external to the turbomachine (for example aerodynamic excitation such as turbulence), etc.

Whatever the source of excitation, the blade, as a mechanical structure, responds to these excitations, which generates stresses that can lead to its damage, or even to its rupture (destruction). Such consequences are of course damaging to the blade in question, but also potentially to the entire turbomachine.

The monitoring of the vibratory behavior of the blades during the phase of designing the turbomachine or during its operational operation therefore proves to be crucial, and presents numerous interests, in particular in terms of predictability of repair and/or replacement operations, of safety (to allow defective equipment to stop before a danger arises), of optimization of the maintenance operations (to allow in particular predictive maintenance), and of reliability.

To carry out such monitoring, strain gauges able to measure the stresses applied to a blade have long been used. To do so, a strain gauge sensor is installed on a blade to be monitored, this sensor also being connected to an acquisition chain by telemetry means. Such an implementation nevertheless proves problematic, for several reasons:
its intrusive nature. Indeed, being fixed to the blade, the strain gauge sensor affects the modal characteristics of the blade, which can induce an error in the analysis of the vibratory behavior of the blade,
the risk of a reduction in the performance of the rotor, the operation of the latter possibly being affected by the presence of one or several sensors attached to the blades,
the complexity, cost, occupied volume and time of installation of a telemetry system. It is further understood that the problems related to all the above-mentioned reasons increase with the number of sensors used, it being understood that it would be appropriate to fix such a sensor on each blade of the rotor.

Also, to overcome these problems, a non-intrusive technique called “BTT” (Blade Tip Timing) technique has been proposed, corresponding to a monitoring technique by means of blade tip timing. This BTT technique consists, for a speed regime, of measuring the actual instants of passage of a blade in front of a fixed proximity sensor (typically arranged on the stator) and of comparing these instants with reference instants obtained for a blade of the same type not subject to vibration (for example a sound blade, that is to say a blade not presenting any mechanical defect). These reference instants can for example be obtained theoretically by digital simulation or following conducted previously tests (for example on a test bench).

From this comparison between actual and reference instants, it is possible to deduce, for each actual instant measured, an amount called amount of “deflection”, providing information on the vibratory behavior of the blade in its dynamic operation (with probable vibrations). For more details on how to calculate said amount of deflection from a pair of instants (actual instant and reference instant) associated with the passage of a blade in front of a proximity sensor, document WO 2018/002818 can be consulted.

Although not intrusive, the BTT technique nevertheless remains deficient in some aspects. Indeed, given its principle of implementation, it only makes it possible to obtain a single sample of the vibratory deformation (i.e. only a single deflection evaluation) per revolution of the blade and per sensor. Therefore, and in practice, the time deflection signal generated over time, due to successive rotations of the blade, is very strongly sub-sampled (the average sampling frequency of the deflection signal is equal to the rotation frequency of the rotor multiplied by the number of sensors used). This harms the accuracy of the evaluation of the vibratory behavior of the blade and therefore in fine the monitoring of the operation of the turbomachine.

In order to provide more samples per blade revolution, it could be envisaged, at least theoretically, to use a large number of sensors. This solution nonetheless remains disadvantageous, on the one hand in terms of costs, but also above all in terms of installation complexity (significant difficulty in arranging a large number of sensors on a circumference of the frame of the turbomachine due to its space requirement as well as to functional constraints specific to the frame).

### DISCLOSURE OF THE INVENTION

The present invention aims to overcome all or part of the drawbacks of the prior art, in particular those set out above, by proposing a solution that allows monitoring the vibratory behavior of the blades of a turbomachine in a more effective manner than the solutions of the prior art.

“More effective”, refers here to a solution for more accurately evaluating the vibratory behavior of the blades, and whose implementation complexity is contained while being inexpensive.

For this purpose, and according to a first aspect, the invention relates to a method for monitoring a turbomachine, said method including, for at least one blade of a rotor equipping the turbomachine, steps of:
obtaining a plurality of samples of at least one analog time signal acquired by means of at least one fixed proximity sensor and representative of a passage of said at least one blade in front of said at least one proximity sensor, said at least one proximity sensor being characterized by a response time adapted to the time signal being representative of the progressiveness of appearance and disappearance of said at least one blade during its passage in front of said sensor,
calculating a deflection of said at least one blade for each of said samples,
determining, in the form of a linear combination of sinusoidal signals, a signal called “approximation signal”, minimizing a cost function evaluating a deviation between said calculated deflections and said approximation signal,
monitoring the vibratory behavior of said at least one blade from frequencies and/or amplitudes and/or phases of the sinusoidal signals forming said approximation signal.

In accordance with the invention, the response time of said at least one proximity sensor (also known as “rise time”) is sufficiently low, for example of the order of a thousandth of a second at most, so that said at least one acquired time signal converts the progressive rise/fall of the physical quantity measured by said at least one proximity sensor.

Thus, unlike the sensors traditionally used to implement the BTT method, the response time of said at least one proximity sensor is here sufficiently low to prevent said at least one acquired time signal from taking the form of a square signal (slot). Such a square signal (corresponding in fine to an “all-or-nothing” signal) indeed does not allow representing the progressiveness of the passage of said at least one blade in front of said at least one proximity sensor. Consequently, such a square signal does not allow obtaining information on a possible offset between the dynamics of said at least one blade and that of a reference blade of the same type.

The monitoring method according to the invention therefore advantageously differs from the state of the art, and more particularly from the BTT method, in that it proposes to combine at least one proximity sensor characterized by a low response time with obtaining a plurality of samples of said at least one acquired time signal. This combination indeed makes it possible to have samples that are distinct from each other since said at least one acquired signal has a bell-shaped profile and not a slot-shaped profile.

In other words, the fact of being able to transcribe the progressiveness of the passage of said at least one blade in front of said at least one proximity sensor advantageously makes it possible to obtain samples whose values, which are distinct from each other, make it possible to finely characterize the vibratory behavior of said at least one blade, by accurately calculating said deflection values. Then, this results in great accuracy in the evaluation of parameters (frequency, amplitude, phase) of the acquired time signal.

If, on the contrary, the acquired signal was a square signal, as in the BTT method, then only one sample should be enough since all the values taken on the upper part of the slot would be identical to each other.

Furthermore, if no limitation is attached to the number of proximity sensors that can be used within the framework of the present invention, it must however be indicated that the implementation of the latter advantageously allows the use of a number of proximity sensors much smaller than the number conventionally used in the BTT method, while allowing achieving high accuracy in the estimation of the quantities characteristic of the vibratory behavior of the blades.

For example, the number of proximity sensors is less than or equal to three.

In particular modes of implementation, the monitoring method can further include one or several of the following characteristics, taken separately or in all technically possible combinations.

In particular modes of implementation, said method further includes a step of calculating, from samples of said at least time signal, a quantity characterizing the duration of the passage of said at least one blade in front of said at least one proximity sensor, the monitoring step also being executed by using said quantity.

Said quantity relating to the duration of passage forms an indicator of the vibratory behavior of said at least one blade. Indeed, in the event of vibration in said at least one acquired time signal, it provides information on the direction of the vibratory displacement at the moment when said at least one blade passes in front of said at least one sensor. Therefore, if the duration of passage is small compared to the duration theoretically obtained for a reference signal, this means that the vibratory movement of said at least one blade occurs in the same direction as the rotation of the rotor (and vice versa, in the opposite direction, if the duration of passage is long compared to that of the reference signal).

In particular modes of implementation, said method further including a step of calculating a quantity characterizing an advance or a delay of said at least one time signal relative to a reference signal representative of a passage in front of said at least one proximity sensor of a blade not undergoing a vibration and of the same type as said at least one blade from which said at least one time signal was acquired, the calculation of said quantity being implemented from samples of said at least one time signal as well as said reference signal, and the monitoring step also being executed by using said quantity.

Said quantity relating to the advance or delay of said at least one time signal also forms an indicator of the vibratory behavior of said at least one blade. Indeed, if this indicator is positive, this means that said at least one blade arrived earlier (i.e. in advance) in said at least one acquired time signal than in a reference signal.

Ultimately, said two quantities (duration of passage, advance or delay) make it possible to obtain information on the overall speed of said at least one blade (rotation speed and vibration speed) as well as on the position of said at least one blade in the vibratory cycle.

In particular modes of implementation, the deviation between said calculated deflections and said approximation signal is evaluated by means of a norm lp, p being a strictly positive real number.

In particular modes of implementation, the index p of the norm lp is strictly comprised between 0 and 2.

In particular modes of implementation, the minimization of the cost function includes the execution of an iteratively reweighted least squares algorithm.

In particular modes of implementation, said at least one sensor is an optical sensor.

In particular modes of implementation, a plurality of analog time signals are acquired due to a plurality of passages of said at least one blade in front of each proximity sensor.

Generally, the inventors have observed that considering a plurality of revolutions of the rotor (and therefore a plurality of passages of said at least one blade in front of the same proximity sensor) was advantageous in that it makes it possible to estimate with great accuracy the amplitudes of the frequencies retained for the approximation signal, and therefore in fine the vibration frequencies of said at least one blade.

According to another aspect, the invention relates to a computer program including instructions for the implementation of a monitoring method according to the invention when said computer program is executed by a computer.

This program can use any programming language, and be in the form of source code, object code or intermediate code between source code and object code, such as in a partially compiled form or in any other desirable form.

According to yet another aspect, the invention relates to an information or recording medium readable by a computer on which a computer program according to the invention is recorded.

The information or recording medium can be any entity or device capable of storing the program. For example, the medium can include a storage means, such as a ROM, for example a CD ROM or a microelectronic circuit ROM, or a magnetic recording means, for example a floppy disk or a hard disk.

On the other hand, the information or recording medium can be a transmissible medium such as an electrical or optical signal, which can be conveyed via an electrical or optical cable, by radio or by other means. The program according to the invention can particularly be downloaded from an Internet type network.

Alternatively, the information or recording medium can be an integrated circuit in which the program is incorporated, the circuit being adapted to execute or to be used in the execution of the method in question.

According to yet another aspect, the invention relates to a device for monitoring a turbomachine, said device including:
an obtaining module configured to obtain a plurality of samples of at least one analog time signal acquired by means of at least one fixed proximity sensor and representative of a passage of at least one blade of a rotor equipping the turbomachine in front of said at least one proximity sensor, said at least one proximity sensor being characterized by a response time adapted to the time signal being representative of the progressiveness of appearance and disappearance of said at least one blade during its passage,
a calculation module configured to calculate a deflection of said at least one blade for each of said samples,
a determination module configured to determine, in the form of a linear combination of sinusoidal signals, a signal called “approximation signal”, minimizing a cost function evaluating a deviation between said calculated deflections and said approximation signal,
a monitoring module configured to monitor the vibratory behavior of said at least one blade from frequencies and/or amplitudes and/or phases of the sinusoidal signals forming said approximation signal.

According to yet another aspect, the invention relates to a system for monitoring a turbomachine, said system including acquisition means including at least one fixed proximity sensor and configured to:
acquire at least one analog time signal representative of a passage of at least one blade of a rotor equipping the turbomachine in front of said at least one proximity sensor, said at least proximity sensor being characterized by a response time adapted to the time signal being representative of the progressiveness of appearance and disappearance of said at least one blade during its passage in front of said sensor,
sample said at least one time signal into a plurality of samples,
said system further including a monitoring device according to the invention.

According to another aspect, the invention relates to an aircraft including a turbomachine equipped with a rotor provided with blades as well as a monitoring system according to the invention.

### BRIEF DESCRIPTION OF THE DRAWINGS

Other characteristics and advantages of the present invention will emerge from the description given below, with reference to the appended drawings which illustrate one exemplary embodiment devoid of any limitation. In the figures:

FIG. 1 schematically represents, in its environment, one embodiment of a monitoring system according to the invention, said system being configured to monitor the operation of a turbomachine equipped with a rotor;

FIG. 2 is a graph representing an example of an analog time signal acquired using a proximity sensor and following the passage of a blade of the rotor in front of said proximity sensor;

FIG. 3 schematically represents an example of hardware architecture of a monitoring device belonging to the monitoring system of FIG. 1;

FIG. 4 represents, in flowchart form, the main steps of a monitoring method according to the invention, as implemented by the monitoring system of FIG. 1;

FIG. 5 is a graph representing an example of offset between, on the one hand, an analog time signal acquired using a proximity sensor and following the passage of a blade of the rotor in front of said proximity sensor, and on the other hand a reference signal;

FIG. 6 schematically represents one particular mode of implementation of the monitoring method of FIG. 4.

### DESCRIPTION OF THE EMBODIMENTS

The present invention fits in the field of the monitoring of the operation of a turbomachine.

For the remainder of the description, the case of a turbomachine of the turbojet engine type equipping an aircraft such as for example a civil aircraft able to carry passengers, is considered without limitation. It should however be noted that the invention remains applicable, with regard to the field of aeronautics, whatever the type of turbomachine considered (turbine engine, turbofan, etc.), as well as for any type of aircraft (plane, helicopter, etc.).

Even more generally, the invention can be applied to any type of turbomachine, independently of the industrial field for which this turbomachine is intended to be used.

Conventionally, said turbomachine (not represented in the figures) is equipped with a rotor provided with a plurality of blades, as well as a stator.

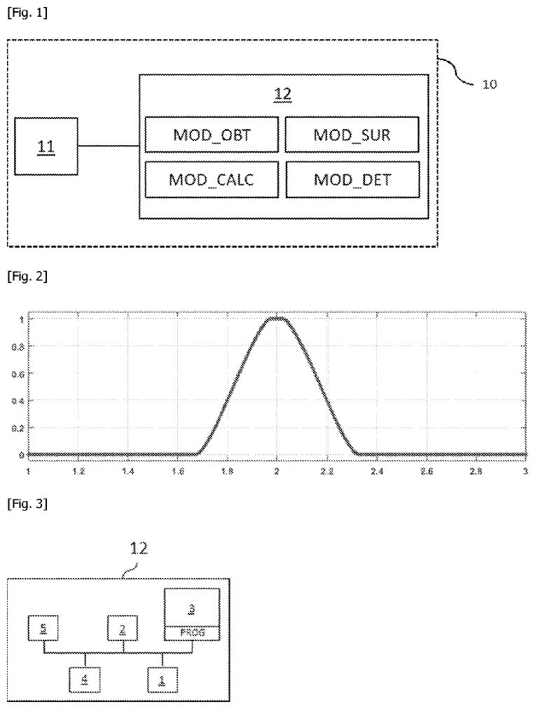

FIG. 1 schematically represents, in its environment, one embodiment of a surveillance system 10 according to the invention.

In the present embodiment, said monitoring system 10 is implemented in the aircraft, for example integrated into the full authority regulation system commonly called FADEC (Full Automatic Digital Engine Control) regulating the operation of the turbomachine. However, no limitation is attached to the location of said monitoring system 10 within the aircraft.

Said monitoring system 10 is configured to determine, when the turbomachine is in operation, one or several quantities characteristic of the vibratory behavior of one or several blades equipping the rotor of said turbomachine. Determining such quantities amounts in particular to performing, when the turbomachine is in operation, a modal analysis of said blade(s), thus making it possible to monitor the appearance and/or the degradation of pre-existing defects.

For this purpose, the monitoring system 10 includes acquisition means 11 configured to acquire at least one analog time signal representative of a passage of at least one blade of the rotor in front of at least one proximity sensor (still known under the name “presence detector”).

No limitation is attached to the number of proximity sensors that can be used within the framework of the present invention. It is nevertheless important to note that its implementation, as described in more detail later, advantageously allows the use of a number of proximity sensors much lower than the one conventionally used in the BTT method, while allowing achieving a high accuracy in the estimation of the quantities characteristic of the vibratory behavior of the blades.

For example, the number of proximity sensors is less than or equal to three. According to an even more particular example, two proximity sensors belong to the acquisition means 11 and are distributed circumferentially so as to be spaced by 95° in the trigonometric direction.

For the remainder of the description, and in order to simplify it, it is now considered without limitation that the acquisition means 11 include a single proximity sensor CAP.

Furthermore, with the same aim of simplification, the invention is now described for a single given blade PAL of the rotor of the turbomachine. It is nevertheless important to note that all of the technical considerations described below can apply without distinction to each of the rotor blades.

It appears from these choices of wording that the expression “at least one analog time signal acquired” refers to the signal(s) acquired following one or several revolutions of the rotors (and therefore one or several passages of the blade PAL in front of the proximity sensor CAP).

Said proximity sensor CAP is fixedly mounted on the turbomachine. For example, said proximity sensor CAP is fixedly arranged on the stator so that the blade part, which passes in front of the sensor CAP, at each revolution of the rotor, corresponds to the distal end of the blade PAL (i.e. the opposite part at the root of the blade PAL) seen along a line of sight orthogonal to the axis of rotation of the rotor.

However nothing excludes envisaging, following other examples not detailed here, other arrangements of the proximity sensor CAP, since the latter is able to detect the presence of the blade PAL at each revolution made by the rotor. Generally, those skilled in the art know how to arrange said proximity sensor CAP to achieve this objective.

The proximity sensor CAP forms a sensitive element configured to provide an electrical signal as a function of the variations in a physical quantity with which said sensor CAP is associated. Said at least one analog time signal is then obtained in a manner known per se from said at least one electrical signal.

In the embodiment of FIG. 1, the proximity sensor CAP used to detect the passage of the blade PAL is an optical sensor (or, equivalently, an optical probe). In other words, the physical quantity associated with such an optical sensor corresponds to the light intensity reflected by the blade PAL towards said optical sensor, the light directed towards the blade PAL coming from a light beam following arrangements known per se.

The choice of an optical sensor however only constitutes a variant of implementation of the invention. Also, other variants can be envisaged, considering for example an inductive sensor, a capacitive sensor, an ultrasonic sensor, a magnetic sensor, etc.

In accordance with the invention, the proximity sensor CAP is characterized by a response time adapted to the acquired time signal being representative of the progressiveness of appearance and disappearance of the blade PAL during its passage in front of the proximity sensor CAP (i.e. in the field of said sensor CAP as regards the present embodiment). In other words, the response time of the proximity sensor CAP (also known as “rise time”) is sufficiently low so that the acquired time signal (which corresponds in fine to the image of the relative position of the end of the blade PAL relative to the position (or field) of the sensor CAP) translates the progressive rise/fall of the physical quantity measured by the proximity sensor CAP.

By way of non-limiting example, the response time of the proximity sensor CAP is less than 35 nanoseconds. Of course, nothing excludes envisaging a response time greater than 35 nanoseconds, the choice of such a value essentially depending on the rotation speed of the blade PAL.

FIG. 2 is a graph representing one example of an analog time signal acquired using the proximity sensor CAP.

More particularly, the signal in FIG. 2 corresponds to the signal acquired following a single passage of the blade PAL in front of the proximity sensor CAP. The abscissa and ordinate axes of the graph in FIG. 2 respectively represent the time and the light intensity reflected by the blade towards the proximity sensor CAP (in the present case, the light intensity is normalized so as to be comprised between 0 and 1).

As illustrated in FIG. 2, the acquired time signal takes the form of a bell, with an ascending/descending phase (oblique and non-vertical slope) corresponding to the progressive entry/exit of the blade PAL in the proximity sensor CAP field.

It is therefore useful to note that, unlike the sensors traditionally used to implement a BTT method, the response time of the proximity sensor CAP is here sufficiently low to prevent the acquired time signal from taking the form of a square signal (slot). Such a square signal (corresponding in fine to an “all-or-nothing” signal) does not in fact make it possible to represent the progressiveness of the passage of the blade PAL in the field of the proximity sensor CAP. Consequently, such a square signal does not make it possible to obtain information on a possible offset between the dynamics of the blade PAL and that of a reference blade of the same type. The invention, for its part, due to the very profile of the signal acquired by means of the proximity sensor CAP (see FIG. 2), makes it possible to characterize such an offset, as will be described in more detail later.

It should be noted that those skilled in the art know how to choose a proximity sensor CAP characterized by a sufficiently low response time within the meaning of the invention, for example in the catalogs of the products offered by specialized manufacturers.

The acquisition means 11 are not limited to the proximity sensor CAP. Indeed, and in a conventional manner, the acquisition means 11 include an acquisition chain into which the proximity sensor CAP is integrated. Said acquisition chain also includes an acquisition card configured to condition said at least electrical signal provided by the proximity sensor CAP, so as to finally deliver said at least one analog time signal corresponding to the variation in light intensity reflected by the blade PAL during its passage in the field of said proximity sensor CAP. The conditioning implemented by the acquisition card includes for example amplification and/or filtering.

Said acquisition means 11 also include, at the output of the acquisition chain, an analog/digital converter configured to digitize said at least one analog time signal. This digitization of said at least one analog time signal makes it possible to obtain a plurality of samples thereof.

With regard to the nature of said at least one time signal, each sample is presented as a pair whose first component corresponds to an acquisition instant, and whose second component corresponds to the light intensity reflected by the blade PAL towards the proximity sensor CAP at said acquisition instant.

It should be noted that the invention advantageously differs from the state of the art, and more particularly from the BTT method, in that it therefore proposes to combine a proximity sensor characterized by a low response time with obtaining a plurality of samples of said at least one acquired time signal. This combination indeed makes it possible to have samples that are distinct from each other since said at least one acquired signal has a bell-shaped profile and not a slot-shaped profile. In other words, the fact of being able to transcribe the progressiveness of the passage of the blade PAL in front of the proximity sensor CAP advantageously makes it possible to obtain samples whose values, which are distinct from each other, will make it possible to characterize the vibratory behavior of the blade PAL as described below. If, on the contrary, the acquired signal was a square signal, as in the BTT method, then only one sample should be enough since all the values taken on the high part of the slot would be identical to each other.

As a purely illustrative numerical example, it can be envisaged that:
the radius R at the end of the rotor blade is of 45 mm,
the rotation speed Ω of the rotor is of 10,000 revolutions/min,
the field of the proximity sensor CAP corresponds to a disk (spot) whose radius is equal to 1.5 mm.

Then the response time T of the proximity sensor CAP is equal to (60×r)/(Π×R×Ω), so that if it is desired to obtain N=10 samples during said response time T, then the sampling frequency must be set equal to N/T, namely here approximately 157 kHz.

In addition to the acquisition means 11, the monitoring system 10 also includes a monitoring device 12 configured to carry out processing operations allowing, from the samples acquired in said at least one time signal, monitoring the vibratory behavior of the blade PAL, by implementing steps of a monitoring method according to the invention.

In the present embodiment, the monitoring device 12 is integrated into the aircraft. It is however noted that this is only a variant of implementation of the invention, and nothing excludes envisaging the case where the monitoring device 12 is implemented on the ground, for example in a premises whose management is ensured by personnel belonging to the company responsible for the design/control/monitoring of the turbomachine.

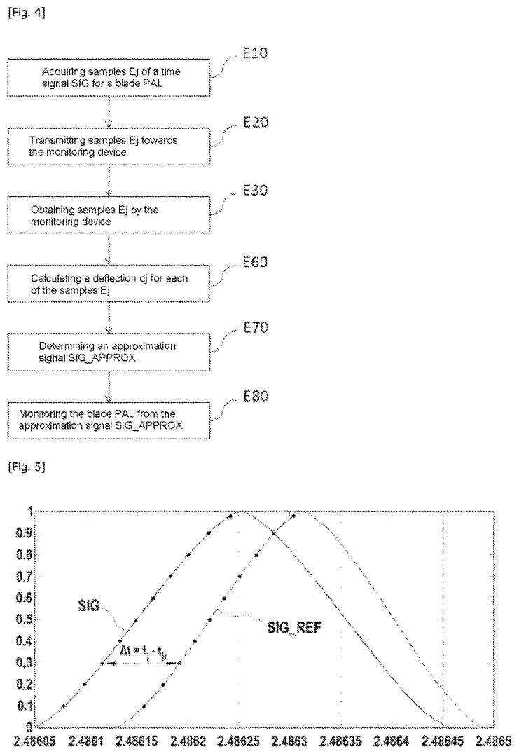

FIG. 3 schematically represents an example of hardware architecture of the monitoring device 12 belonging to the monitoring system 10 of FIG. 1.

As illustrated in FIG. 3, the monitoring device 12 according to the invention has the hardware architecture of a computer. Thus, said monitoring device 12 includes, in particular, a processor 1, a read-access memory 2, a read only memory 3 and a non-volatile memory 4. It also has communication means 5.

The read only memory 3 of the monitoring device 12 constitutes a recording medium in accordance with the invention, readable by the processor 1 and on which a computer program PROG in accordance with the invention is recorded, including instructions for the execution of steps of the monitoring method according to the invention. The program PROG defines functional modules of the monitoring device 12, which rely on or control the hardware elements 1 to 5 of said monitoring device 12 cited above, and which comprise in particular:
an obtaining module MOD_OBT configured to obtain the plurality of samples from said at least one analog time signal acquired by the acquisition means 11,
a calculation module MOD_CALC configured to calculate a deflection of the blade PAL for each of the acquired samples,
a determination module MOD_DET configured to determine, in the form of a linear combination of sinusoidal signals, a signal called “approximation signal”, minimizing a cost function evaluating a deviation between said calculated deflections and said approximation signal,
a monitoring module MOD_SUR configured to monitor the vibratory behavior of the blade PAL from (i.e. by using) frequencies and/or amplitudes and/or phases of the sinusoidal signals forming said approximation signal.

The communication means 5 allow in particular the monitoring device 12 to receive data coming from other entities, particularly samples of said at least one time signal, after these samples have been acquired by said acquisition means 11, themselves provided in this case with communication means suitable for the emission. These communication means 5 rely, in a manner known per se, on a communication interface able to exchange data between the monitoring device 12 and another entity.

No limitation is attached to the nature of this communication interface (wired, non-wired, computer bus, message routing unit called “ACARS” (Airline Communications, Addressing and Reporting System), etc.), so as to allow the exchange of data according to any protocol known to those skilled in the art (Ethernet, Wi-Fi, Bluetooth, 3G, 4G, 5G, TCP-IP, etc.).

In the present embodiment, the term “obtaining” the module MOD_OBT refers to receiving, directly from the acquisition means 11, the samples acquired for said at least one time signal. Consequently, in the present embodiment, the obtaining module MOD_OBT is integrated into the communication means 5.

Nothing excludes that the monitoring device 12 will obtain, via its obtaining module MOD_OBT, the samples after they have been stored in storage means, such as for example a dedicated database, placed between the acquisition means 11 and said monitoring device 12.

Moreover, the present invention still covers other embodiments in which the acquisition means 11 are integrated into the monitoring device 12. In such other embodiments, it is understood that the term “obtaining” then refers to the acquisition as such of the samples of said at least one time signal.

Generally, no limitation is attached to the way in which the monitoring device 12 obtains the samples acquired by the acquisition means 11.

FIG. 4 represents, in flowchart form, the main steps of the monitoring method according to the invention, as implemented by the monitoring system 10 of FIG. 1.

With the aim of simplifying the description of the monitoring method, and unless otherwise stated, the case of a single revolution of the rotor and therefore, consequently, a single passage of the blade PAL in front of the proximity sensor CAP is now considered in a non-limiting manner. It should however be noted that the description of the monitoring method of course adapts to the case of a plurality of revolutions of the rotor.

For the remainder of the description, it is further considered that a reference signal SIG_REF has been previously obtained and is stored by the monitoring device 12, for example in the non-volatile memory 4. This reference signal SIG_REF is representative of a passage of the blade PAL in front of the sensor CAP when said blade PAL is not subject to vibration. More particularly, in the present mode of implementation, the reference signal SIG_REF is associated with a sound blade (i.e. devoid of design defects, and having not suffered any mechanical fatigue) of the same type as said blade PAL, and is generated by digital simulation. However, nothing excludes envisaging other modes for obtaining said reference signal SIG_REF, following a test campaign on a test bench.

As illustrated in FIG. 4, the monitoring method initially includes a step E10 of acquiring a plurality of samples Eⱼ (j is an integer index). Said step E10 is implemented by the acquisition means 11.

To the extent that the present mode of implementation is described by considering a single revolution of the rotor, it is understood that the samples Eⱼ obtained due to the execution of step E10 all belong to a single analog time signal SIG. Of course, if several rotor revolutions are taken into consideration, then samples are acquired for a plurality of analog time signals (i.e. as many time signals as rotor revolutions).

The monitoring method also includes a step E20 of transmitting (emitting) the samples Eⱼ acquired from the acquisition means 11 towards the monitoring device 12. Said step E20 is implemented by suitable communication means equipping the acquisition means 11.

The monitoring method also includes a step E30 of obtaining (receiving), by the monitoring device 12, said plurality of samples Eⱼ. Said step E30 is implemented by the obtaining module MOD_OBT equipping the monitoring device 12.

The monitoring method also includes a step E60 of calculating, by the monitoring device 12, a deflection of the blade PAL for each of the samples Eⱼ. Said step E60 is implemented by the module MOD_CALC equipping the monitoring device 12.

It should be noted that the transmission of the samples Eⱼ acquired from the acquisition means 11 to the monitoring device 12, can be performed in different ways. For example, as soon as a sample is acquired, it is transmitted to the monitoring device 12 (i.e. the samples are transmitted one by one), and a deflection of the blade PAL is calculated for this transmitted sample. In this case, “obtaining said plurality of samples” results from the iteration, for each of the samples, of the receipt of said sample and the calculation of a deflection for said sample.

As a variant, a plurality of samples (possibly all of the samples acquired) can be transmitted at once towards the monitoring device 12.

The deflection of the blade PAL, for a sample Eⱼ, is calculated in accordance with the principles described in document WO 2018/002818 already mentioned before.

In practice, if the acquisition instant associated with a sample Eⱼ of the signal SIG is noted ti, the deflection di calculated for said sample Eⱼ is written:

$${d}_{j} = R \times Ω \times ( {t}_{j} - {t}_{jr} ) = R \times Ω \times Δ t$$

expression in which tⱼᵣ represents the instant of the reference signal SIG_REF in correspondence with said instant tⱼ of the signal SIG, i.e. tⱼᵣ is the instant of the reference signal SIG_REF in which the light intensity is equal to the light instant associated with the sample Eⱼ. In other words, the quantity Δt makes it possible to evaluate, at constant light intensity, the offset between the signals SIG and SIG_REF.

FIG. 5 schematically represents an example of offset between the signals SIG and SIG_REF.

Points are represented on the rising parts of the curves associated with said signals SIG and SIG_REF. These points, with regard to the signal SIG, correspond to the samples acquired on said rising part. The other points, with regard to the reference signal SIG_REF, refer to the points in correspondence with the samples of the signal SIG.

It should be noted that no point is illustrated on the descending parts of the curves in FIG. 5. However, this is only a simplified representation, it being understood that samples can also be acquired on the descending part of the signal SIG.

Once the deflections di have been calculated for the samples Eⱼ, the monitoring method includes a step E70 of determining, in the form of a linear combination of sinusoidal signals, a signal called “approximation signal” SIG_APPROX, minimizing a cost function evaluating a deviation between said deflections dj calculated and said approximation signal SIG_APPROX. Said step E70 is implemented by the determination module MOD_DET equipping the monitoring device 12.

In practice, seeking an approximation of the deflections di by sinusoidal signals amounts to considering the following formulation:

$${d}_{j} ( t ) = SIG\_APPROX ( t ) + e ( t )$$

formulation in which:
t is the time variable taking its values in an interval representative of the duration of the passage of the blade PAL in front of the proximity sensor CAP, for example an interval bounded by the minimum and maximum of the acquisition instants associated with the samples Eⱼ of the signal SIG,
e(t) corresponds to an approximation error.

The determination of the approximation signal SIG_APPROX is conventionally carried out by means of an interpolation and extrapolation algorithm by Discrete Fourier transform, for example with a high time resolution.

Consequently, the signal SIG_APPROX is written in the following form:

$$SIG\_APPROX ( t ) = {\sum }_{\{ l ∈ F \}} {c}_{l} exp ( 2 j π \times {f}_{l} \times t )$$

expression in which:
   j represents here the complex number such that j²=−1,
      F corresponds to a given set of candidate frequencies for the approximation. In other words, F is of finite cardinal, and can be chosen according to the knowledge on the dynamics of the blades such as the blade PAL (it is understood that the greater the cardinal of F, the more the determination of SIG_APPROX consumes computing resources),
      fₗ corresponds to a frequency of the set F,
         cₗ corresponds to the amplitude of the sinusoidal signal having fₗ as frequency.

Ultimately, the minimization of the cost function making it possible to determine said approximation signal SIG_APPROX is expressed as follows:

$${}_{{c}_{l}}^{min} ‖ {d}_{j} ( t ) - {\sum }_{\{ l ∈ F \}} {c}_{l} exp ( 2 j π \times {f}_{l} \times t ) ‖$$

The norm ∥·∥ corresponds for example to a norm |p, p being a strictly positive real number. In this case, the minimization of the cost function is written:

$${}_{{c}_{l}}^{min} {\vert {d}_{j} ( t ) - {\sum }_{\{ l ∈ F \}} {c}_{l} exp ( 2 j π \times {f}_{l} \times t ) \vert}^{p}$$

The exponent p is for example comprised between 0 and 2. The inventors have indeed observed that choosing such an exponent p makes it possible to cancel a significant part of the coefficients cₗ, which contributes to lightening the computational load. As a more specific example, the coefficient p is equal to 1.

It should be noted that, in general, no limitation is attached to the choice of the exponent p, which can therefore be greater than 2. It should nevertheless be noted that considering p comprised between 0 and 2 contributes to ensuring a statistical distribution of the error (i.e. noise) finer than that of a Gaussian probability law (case where p is equal to 2). However, to the extent that noise generally admits a non-Gaussian and parsimonious distribution, a value of p greater than 2 constitutes a risk of less efficient approximation of the deflections.

Algorithmically, the minimization of the cost function can be performed in accordance with any suitable optimization technique known to those skilled in the art. For example, the minimization of the cost function includes the execution of an iteratively reweighted least squares algorithm, also known as IRLS (Iterative Reweighted Least-Squares) algorithm.

Ultimately, said approximation signal SIG_APPROX, in that it makes it possible to approximate the deflections di calculated during the revolution of the rotor (and therefore of the blade PAL), characterizes the vibratory behavior of said blade PAL. It is therefore possible to access the frequencies and/or amplitudes and/or phases of the sinusoidal signals forming said approximation signal SIG_APPROX.

For this purpose, the monitoring method includes a step E80 of monitoring the blade PAL from frequencies and/or amplitudes and/or phases of the sinusoidal signals forming said approximation signal SIG_APPROX. Said step E80 is implemented by the module MOD_SUR equipping the monitoring device 12.

In the present mode of implementation, said monitoring step E80 includes an extraction of parameters (frequencies, amplitudes, phases) considered to be of interest in the approximation signal SIG_APPROX. Collecting such parameters makes it possible to characterize the vibratory behavior of the blade PAL during the revolution of the rotor, which therefore participates in the monitoring of said blade PAL.

The extraction of the parameters can also be supplemented by an analysis thereof, in order to determine whether or not the vibratory behavior of the blade PAL is faulty.

This analysis of the parameters for example includes a comparison of the quantitative parameters (amplitudes and/or phases) with given thresholds.

Of course, the monitoring step E80 can also include the emission of an alert in the case where one or several anomalies (example threshold overrun) are observed for one or several parameters extracted from the approximation signal SIG_APPROX.

Moreover, it can be noted that the calculation E60, determination E70 as well as monitoring E80 steps can be executed during a flight of the aircraft but also, according to another example, in a deferred manner (for example if the samples are stored by the monitoring device 12 in its non-volatile memory 4).

It is recalled here that the mode of implementation of FIG. 4 has been described by considering a single revolution of the rotor, and therefore a single passage of the blade PAL in front of the proximity sensor CAP. That being said, and as already mentioned before, the fact of considering only one revolution of the rotor does not constitute a limiting factor of the invention. Also, when a plurality of revolutions of the rotor is considered, a plurality of analog time signals SIG_1, SIG_2, . . . are acquired by the acquisition means 11 (the number of signals acquired is even higher if a plurality of proximity sensors, or also a plurality of blades of the rotor is considered). Each signal SIG_i (i being an integer index) of said plurality of signals provides samples which are processed by the monitoring device 12.

From then on, and following one particular mode of implementation, the monitoring device 12 determines a single approximation signal SIG_APPROX by taking into account all of the deflections calculated from the samples of all the signals SIG_1, SIG_2, etc. In other words, all of the deflections form a signal defined piecewise over time (each piece corresponds to a passage of the blade PAL in front of the proximity sensor CAP), an approximation of which is sought via the determination of said approximation signal SIG_APPROX.

Generally, the inventors have observed that considering a plurality of revolutions of the rotor (and therefore a plurality of passages of the blade PAL in front of the same proximity sensor) was advantageous in that it allows estimating with great accuracy the amplitudes (i.e. the parameters ci) of the frequencies retained for the approximation signal, and therefore in fine the vibration frequencies of said at least one blade.

However nothing excludes envisaging other modes of implementation, such as for example a mode in which the monitoring device 12 determines, for each signal SIG_i, an approximation signal SIG_APPROX_i which approximates the deflections calculated from the samples of said signal SIG_i. In this case, the monitoring of the vibratory behavior of the blade PAL can be performed at each revolution.

The monitoring method has also been described until now considering that it comprises said acquisition E10 and transmission E20 steps. It is then noted that said step E10 can be seen as a “step of obtaining a plurality of samples” within the meaning of the invention.

The invention also covers other modes in which, when the acquisition means 11 are distinct from (and therefore not integrated into) the monitoring device 12, said steps E10 and E20 do not belong to the monitoring method, and are carried out prior to the implementation of said monitoring method. In this case, only step E30 described above can be seen as a “step of obtaining a plurality of samples” within the meaning of the invention, and the monitoring method is then implemented by the sole monitoring device 12.

According to still other modes of implementation, it is possible to envisage that the monitoring step E80 is carried out by an operator on the ground rather than by the monitoring device 12.

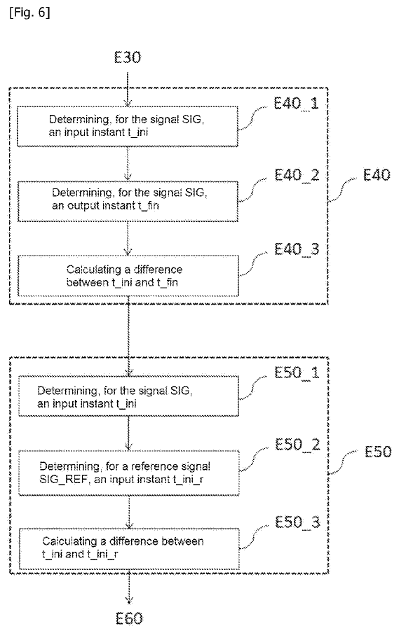

FIG. 6 schematically represents one particular mode of implementation of the monitoring method of FIG. 4.

In the particular mode of FIG. 6, the monitoring method further includes a step E40 of calculating, from (i.e. by using) samples of the signal SIG (i.e. the samples obtained by the monitoring device 12 following the execution of step E30), of a quantity Q1 characterizing the duration of the passage of the blade PAL in front of the proximity sensor CAP (i.e. the duration of crossing of said proximity sensor CAP field by the blade PAL). Moreover, the monitoring step E80 is also executed by using said quantity Q1.

To calculate the quantity Q1, and as illustrated in FIG. 6, said calculation step E40 includes:
a determination (sub-step E40_1), for the time signal SIG, of an input instant t_ini of the blade PAL in the field of said proximity sensor CAP,
a determination (sub-step E40_2), for the time signal SIG, of an output instant t_fin of the blade PAL in the field of said proximity sensor CAP,
a calculation (sub-step E40_3) of a difference between said output instant t_fin and said input instant t_ini.

The determination of the input instant t_ini (respectively of the output instant t_fin) can for example consist of selecting, among the samples Eⱼ of the signal SIG and by going through these samples Eⱼ by increasing acquisition instants, the first sample (respectively the last sample) whose associated light intensity value is non-zero.

According to a more particular example of implementation, the determination of the input instant t_ini (respectively of the output instant t_fin) consists of selecting, among the samples Eⱼ of the signal SIG and by going through these samples Eⱼ by increasing acquisition instants, the first sample (respectively the last sample) whose associated light intensity value is above a given threshold.

Considering such a threshold is advantageous to the extent that the measured signal SIG is generally noisy. Consequently, the use of such a threshold makes it possible to avoid considering a sample associated with a non-zero light intensity value, when it is in reality zero.

It is important to note that the implementation of step E40 is not limited to determining the input instant t_ini (respectively the output instant t_fin) among the samples Eⱼ acquired. Indeed, nothing excludes considering a sample of the signal SIG not corresponding to a sample acquired during step E10, and obtained for example by interpolation between two samples chosen among said samples Eⱼ.

It is also possible to envisage, in combination or not with the previous examples of implementation, smoothing the measured signal SIG (for example by means of adapted filtering), so as to prevent the profile of the signal SIG from having several rise and/or output instants for one and the same passage of the blade PAL in front of the proximity sensor CAP. Such false instants may result from a sound effect that may complicate the implementation of step E40.

Said quantity Q1 forms an indicator of the vibratory behavior of the blade PAL. Indeed, in the event of vibration in the signal SIG, it provides an indication on the direction of the vibratory displacement at the moment of crossing of the sensor CAP field by the blade PAL. Therefore, if the duration of crossing of the signal SIG is small compared to that of the reference signal SIG_REF, this means that the vibratory movement of the blade PAL is in the same direction as the rotation of the rotor (and vice versa, in the opposite direction, if the duration of crossing of the signal SIG is long compared to that of the reference signal SIG_REF).

Alternatively to the determination of the quantity Q1, it can also be envisaged to determine, when the signals are normalized, an indicator corresponding to the area of the surface located below the curve of the signal SIG and comprised between the input t_ini and output t_fin instants. This indicator is “similar” to the quantity Q1 in that it also makes it possible to provide information on the direction of the vibratory movement of the blade PAL (by comparison with the corresponding area located under the curve of the reference signal SIG_REF).

In the particular mode of FIG. 6, the monitoring method also includes a step E50 of calculating a quantity Q2 characterizing an advance or a delay of the time signal SIG relative to the reference signal SIG_REF, the calculation of said quantity Q2 being implemented from samples of said signals SIG and SIG_REF. Moreover, the monitoring step E80 is also executed by using said quantity Q2.

Said advance or delay of the signal SIG relative to the reference signal SIG_REF is also called “order of arrival” of the blade PAL in the field of the proximity sensor CAP.

To calculate the quantity Q2, and as illustrated in FIG. 6, said calculation step E50 includes:
a determination (sub-step E50_1), for the time signal SIG, of an input instant t_ini of the blade PAL in the field of said proximity sensor CAP (in this case, this is a sub-step identical to sub-step E40_1 described above),
a determination (sub-step E50_2), for the reference signal SIG_REF, of an input instant t_ini_r of the blade PAL in the field of said proximity sensor CAP,
a calculation (sub-step E50_3) of a difference between said instants t_ini and t_ini_r.

The input instant t_ini_r represents the instant of the reference signal SIG_REF in correspondence with said input instant t_ini of the signal SIG, i.e. t_ini_r is the instant of the reference signal SIG_REF at which the light intensity is equal to the light instant measured by the signal SIG at said input instant t_ini.

The technical considerations mentioned above in relation to the calculation step E40 and which concern the possibility of taking into account a threshold and/or a smoothing of the signal SIG and/or an interpolation between samples can of course also be applied as regards the execution of said calculation step E50.

Said quantity Q2 also forms an indicator of the vibratory behavior of the blade PAL. Indeed, if this indicator is positive, this means that the blade PAL arrived earlier (i.e. in advance) in the signal SIG than in the reference signal SIG_REF (and vice versa).

Ultimately, the two quantities Q1 and Q2 make it possible to obtain information on the overall speed of the blade PAL (rotation speed and vibration speed) as well as on the position of the blade PAL in the vibration cycle. This information is deduced and analyzed during the monitoring step E80.

The calculations of said quantities Q1 and Q2 are also advantageous in the case where the speed regime is constant and where the vibrations affecting the blade PAL are single-frequency vibrations (i.e. unimodal vibrations). Indeed, in this case, the quantities Q1 and Q2 make it possible to determine whether said vibrations are synchronous or asynchronous.

Indeed, for a synchronous vibration, the duration of crossing of the field of the proximity sensor CAP, that is to say the quantity Q1, is constant during the different revolutions of the rotor (i.e. during the different passages of the blade PAL in front of the proximity sensor CAP). Likewise, the order of arrival of the blade PAL, that is to say the quantity Q2, is constant and of the same sign during the different revolutions of the rotor.

Conversely, for an asynchronous vibration, the duration of crossing of the proximity sensor CAP field, that is to say the quantity Q1, and the order of arrival of the blade PAL are variable.

It should be noted that the monitoring method of FIG. 6 has been described by considering that steps E40 and E50 are executed before the calculation E60 and determination E70 steps. However, this is only one variant of implementation of the invention, and other variants can be envisaged since the quantities Q1 and Q2 are calculated after obtaining the samples Eⱼ (step E30) and before the monitoring step E80.

The monitoring method of FIG. 6 was also described by considering that the quantities Q1 and Q2 were both calculated. The invention nevertheless remains applicable in cases where only one of said two quantities Q1, Q2 is calculated. In other words, the invention covers modes of implementation in which only step E40 or only step E50 is implemented.

Moreover it is noted that to implement step E40 (respectively step E50), the monitoring system 10 also includes, compared to the system illustrated in FIG. 1, a calculation module configured to calculate said quantity Q1 (respectively a calculation module configured to calculate said quantity Q2). This calculation module is defined by specific additional instructions from the program PROG.

In one variant of embodiment, the calculation module configured to calculate said quantity Q1 (respectively a calculation module configured to calculate said quantity Q2) is a dedicated module, distinct from the calculation module MOD_CALC configured to calculate the deflections di.

In another variant of embodiment, the calculation module MOD_CALC configured to calculate the deflections dj is also configured to calculate the quantity Q1 (respectively the quantity Q2).

1. A method for monitoring a turbomachine, said method including, for at least one blade of a rotor equipping the turbomachine, steps of:
obtaining a plurality of samples of at least one analog time signal acquired by means of at least one fixed proximity sensor and representative of a passage of said at least one blade in front of said at least one proximity sensor, said at least one proximity sensor being characterized by a response time adapted to the time signal being representative of the progressiveness of appearance and disappearance of said at least one blade during its passage,
calculating a deflection of said at least one blade for each of said samples,
determining, in the form of a linear combination of sinusoidal signals, a signal called “approximation signal”, minimizing a cost function evaluating a deviation between said calculated deflections and said approximation signal,
monitoring the vibratory behavior of said at least one blade from frequencies and/or amplitudes and/or phases of the sinusoidal signals forming said approximation signal.

2. The method according to claim 1, said method further including a step of calculating, from samples of said at least time signal, a quantity characterizing the duration of the passage of said at least one blade in front of said at least one proximity sensor, the monitoring step also being executed by using said quantity.

3. The method according to claim 1, said method further including a step of calculating a quantity characterizing an advance or a delay of said at least one time signal relative to a reference signal representative of a passage in front of said at least one proximity sensor of a blade not undergoing vibration and of the same type as said at least one blade from which said at least one time signal was acquired, the calculation of said quantity being implemented from samples of said at least one time signal as well as from said reference signal, and the monitoring step also being executed by using said quantity.

4. The method according to claim 1, wherein the deviation between said calculated deflections and said approximation signal is evaluated by means of a norm lp, p being a strictly positive real number.

5. The method according to claim 4, wherein the index p of the norm lp is strictly comprised between 0 and 2.

6. The method according to claim 1, wherein the minimization of the cost function includes the execution of an iteratively reweighted least squares algorithm.

7. The method according to claim 1, wherein said at least one sensor is an optical sensor.

8. The method according to claim 1, wherein the number of proximity sensors is less than or equal to three.

9. The method according to claim 1, wherein a plurality of analog time signals are acquired due to a plurality of passages of said at least one blade in front of each proximity sensor.

10. (canceled)

11. A non-transitory computer readable medium having stored thereon instructions which, when executed by a processor, cause the processor to implement the method of claim 1.

12. A device for monitoring a turbomachine, said device including:
an obtaining module configured to obtain a plurality of samples of at least one analog time signal acquired by means of at least one fixed proximity sensor and representative of a passage of at least one blade of a rotor equipping the turbomachine in front of said at least one proximity sensor, said at least one proximity sensor being characterized by a response time adapted to the time signal being representative of the progressiveness of appearance and disappearance of said at least one blade during its passage,
a calculation module configured to calculate a deflection of said at least one blade for each of said samples,
a determination module configured to determine, in the form of a linear combination of sinusoidal signals, a signal called “approximation signal”, minimizing a cost function evaluating a deviation between said calculated deflections and said approximation signal,
a monitoring module configured to monitor the vibratory behavior of said at least one blade from frequencies and/or amplitudes and/or phases of the sinusoidal signals forming said approximation signal.

13. The system for monitoring a turbomachine, said system including acquisition means including at least one fixed proximity sensor and configured to:
acquire at least one analog time signal representative of a passage of at least one blade of a rotor equipping the turbomachine in front of said at least one proximity sensor, said at least one proximity sensor being characterized by a response time adapted to the time signal being representative of the progressiveness of appearance and disappearance of said at least one blade during its passage,
sample said at least one time signal into a plurality of samples, said system further including a monitoring device according to claim 12.

14. An aircraft including a turbomachine equipped with a rotor provided with blades as well as a monitoring system according to claim 13.
